(19) United States
(12) Patent Application Publication
(10) Pub. No.: US 2021/0283846 A1
(43) Pub. Date: Sep. 16, 2021

(54) EMPTYING VESSELS IN A BUILD DEVICE

(71) Applicant: HEWLETT-PACKARD DEVELOPMENT COMPANY, L.P., Spring, TX (US)

(72) Inventors: David R. Otis, JR., Corvallis, OR (US); Steve Ringwald, Corvallis, OR (US); Kevin E. Swier, Corvallis, OR (US)

(21) Appl. No.: 16/608,853

(22) PCT Filed: Dec. 21, 2017
(86) PCT No.: PCT/US2017/067891

§ 371 Date: Oct. 27, 2019

(51) Int. Cl. B29C 64/357; B29C 64/255; B29C 64/393; B29C 64/329; B22F 12/52; B22F 12/90; B22F 10/73; B22F 10/85; B33Y 10/00; B33Y 30/00; B33Y 50/02; B33Y 40/00

(52) U.S. Cl. CPC B29C 64/357; B29C 64/255; B29C 64/393; B29C 64/329; B22F 12/52; B33Y 40/00; B22F 10/73; B22F 10/85; B33Y 10/00; B33Y 30/00; B33Y 50/02; B22F 12/90

(57) ABSTRACT

A build device and a method of operating the build device are disclosed. In a method provided, a build material is directed to an intermediate vessel from a conveying line. The build material is separated from an air stream and dropped into the intermediate vessel. The intermediate vessel is emptied between a first build operation and a second build operation.

### BACKGROUND

Three-dimensional (3D) printing may produce a 3D object by adding successive layers of build material, such as powder, to a build platform, then selectively solidifying portions of each layer under computer control to produce the 3D object. The build material may be powder, or powder-like material, including metal, plastic, ceramic, composite material, and other powders. The powder may be formed from, or may include, short fibers that may have been cut into short lengths from long strands or threads of material. The objects formed can be various shapes and geometries, and may be produced using a model, such as a 3D model or other electronic data source. The fabrication may involve laser melting, laser sintering, heat sintering, electron beam melting, thermal fusion, and so on. The model and automated control may facilitate the layered manufacturing and additive fabrication.

### DESCRIPTION OF THE DRAWINGS

Certain examples are described in the following detailed description and in reference to the following drawings.

FIG. 1 is a drawing of a conveying system for a build device that uses intermediate vessels, IV1 and IV2, to hold build material in the build device, in accordance with examples.

FIG. 2 is a drawing of a 3D printer, in accordance with examples.

FIG. 3 is a schematic diagram of a 3D printer having a new material vessel that discharges new build material through a new feeder into a conveying system, in accordance with examples.

FIG. 4 is a block diagram of a 3D printer, in accordance with examples.

FIG. 5 is a drawing of a vessel, or hopper, in a 3D printer, in accordance with examples.

FIG. 6 is a drawing of the hopper, showing the size differences between the upper and lower portions, in accordance with examples.

FIG. 7 is a block diagram of a controller for operating a supply station in a 3D printer, in accordance with examples.

FIG. 8 is a process flow diagram of a method for operating a 3D printer, in accordance with examples.

FIG. 9 is a simplified process flow diagram of a method for operating a 3D printer, in accordance with examples.

FIG. 10 is a block diagram of a non-transitory, machine readable medium comprising code to operate a 3D printer, in accordance with examples.

FIG. 11 is a simplified block diagram of a non-transitory, machine readable medium comprising code to operate a 3D printer, in accordance with examples.

### DETAILED DESCRIPTION

Three dimensional printers may form 3D objects from different kinds of powder or powder-like build material. The cost of producing 3D objects using a 3D printer may be related to the cost of the build material. The current situation may be to have dedicated 3D printers for build objects with a single kind of build material.

Thus, there may be a desire for 3D printers to save build material after build operations, and utilize recycled material as build material in subsequent build operations. Recycled build material may include, for example, build material that was used during a 3D printing process but which was not solidified during the 3D printing process. Such non-solidified build material may be recovered once a 3D printing process has completed and may be designated ‘recycled build material’ and reused in other 3D printing processes. For some applications, there may be benefit in utilizing new, i.e., previously unused, material because of reasons such as product purity, strength, and finish in certain instances. For some applications, a mix of new and recycled build material may be used, for example as a compromise between low cost and acceptable 3D object properties. For example, in some examples using about 20% new and about 80% recycled build material may be acceptable from both an economic and a quality perspective. Other proportions of new and recycled build material may be used depending on build material properties and acceptable object quality characteristics.

Generally, 3D printers are only used with a single type of build material to avoid cross-contamination between different kinds of build material. Some printers may be capable of using different kinds of build material, but this may not be done frequently as the printer must be purged of one type of build material, prior to using a different kind of build material. The purging operation may be complicated to lower the chances of cross-contamination of different kinds of build materials. There may be significant value in having a single 3D printer that is capable of using multiple kinds of build material, and in which switching from one material to another is quick and relatively easy.

Examples described herein provide build devices, such as 3D, printers that are easily cleared of current build material and methods for operating the build devices to empty the current build material to vessels or containers. For example, hoppers in the 3D printer may be used in the conveyance system to separate build material from conveying air, and provide the build material to other units, such as a build enclosure or a recycle supply station, among others. These hoppers may be sized to lower the amount of build material held at the end of a build operation. The hoppers may be automatically emptied of build material when the build operation is completed. This may make switching to a new build material easier, as the hoppers and lines may be emptied to vessels that may be removed from the 3D printer and stored while another material is used.

In one example, the build material may be a dry, or substantially dry, powder or powder-like material. In a three-dimensional printing example, the build material may have an average volume-based cross-sectional particle diameter size of between about 5 and about 400 microns, between about 10 and about 200 microns, between about 15 and about 120 microns or between about 20 and about 70 microns. Other examples of suitable, average volume-based particle diameter ranges include about 5 to about 70 microns, or about 5 to about 35 microns. As used herein, a volume-based particle size is the size of a sphere that has the same volume as the powder particle. The average particle size is intended to indicate that most of the volume-based particle sizes in the container are of the mentioned size or size range. However, the build material may include particles of diameters outside of the mentioned range. For example, the particle sizes may be chosen to facilitate distributing build material layers having thicknesses of between about 10 and about 500 microns, or between about 10 and about 200 microns, or between about 15 and about 150 microns. One example of a manufacturing system may be pre-set to distribute powdered material layers of about 80 microns using build material containers that include build material having average volume-based particle diameters of between about 40 and about 60 microns. An additive manufacturing apparatus may also be configured or controlled to form powder layers having different layer thicknesses.

The build material can be, for example, a semi-crystalline thermoplastic material, a metal material, a plastic material, a composite material, a ceramic material, a metal material, a glass material, a resin material, or a polymer material, among other types of build material. Further, the build material may include multi-layer structures wherein each particle comprises multiple layers. In some examples, a center of a build material particle may be a glass bead, having an outer layer comprising a plastic binder to agglomerate with other particles for forming the structure. Other materials, such as fibers, may be included to provide different properties, for example, strength or conductivity, among others.

A material handling system may mix recycle material and new material to provide a build material mix to be used in a 3D printing process. The 3D printers described herein may also provide for the recovery of excess or non-solidified build material at the end of a 3D printing process. The recovered material may be held in the printer for use in further build processes. In some examples, the recovered material may be moved into a build material container which may then be removed from the 3D printer for storage, recycling, or for later use. For example, intermediate vessels in the 3D printer, such as hoppers, may be emptied between build operations to facilitate a change in build material. The intermediate vessels may be emptied to larger storage vessels in the 3D printer, a removable build material container, or both. The larger vessels or removable build material containers may then be taken out of the printer, or placed out of service during the build using a different material.

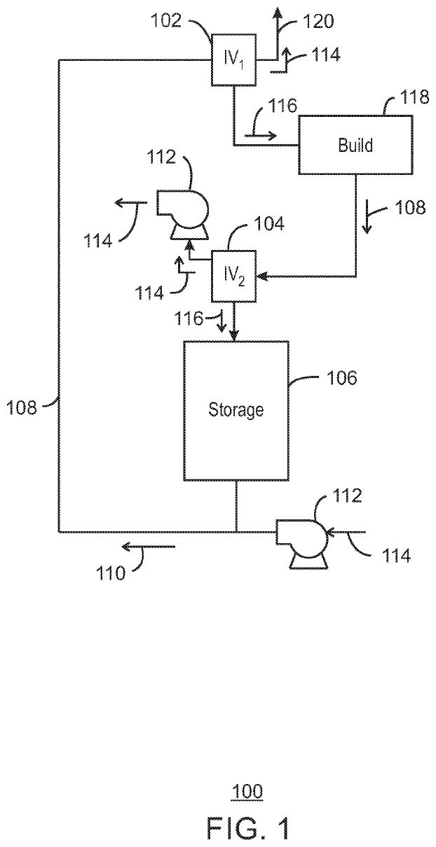

FIG. 1 is a drawing of a conveying system 100 for a build device that uses intermediate vessels, IV1 102 and IV2 104, to hold build material in the build device, in accordance with examples. The build device may be a 3D printer, 2D printer, or any other device that transfers a build material, toner, or other powder, through a conveying system, using air pressure. The build material may be held in a storage vessel 106, for example, that may be removed and replaced with a storage vessel 106 holding a different kind of build material.

The build material may be dispensed from the storage vessel 106 into a conveying line 108, where it forms a suspension 110 in an air stream. A blower 112 may provide the air stream. In some examples, the blower 112 may be placed at the end of a conveying line 108 to create a low-pressure air flow that conveys the material. The intermediate vessels, IV1 102 and IV2 104, allow separation of air 114 from the suspension 110, for example, through a coupled air-separator, such as a filter or cyclone. The intermediate vessels, IV1 102 and IV2 104 also store an amount of build material for a next process, such as dispensing a flow 116 to a build chamber 118, or returning a flow 116 of recycled material to the storage vessel 106. The air 114 may be released through a vent line 120, or pulled out by a blower 112.

Changing materials to use a different kind of material in a build device may be advantageous, however, cross-contamination may be a problem. In examples described herein, the intermediate vessels IV1 102 and IV2 104 are sized to allow the material to be purged between completed build, or print, operations. This may be used to allow a new material to be loaded into the build device for a next build or print operation, for example, by emptying material to the storage vessel 106, then replacing the storage vessel 106 with a storage vessel 106 that includes new material.

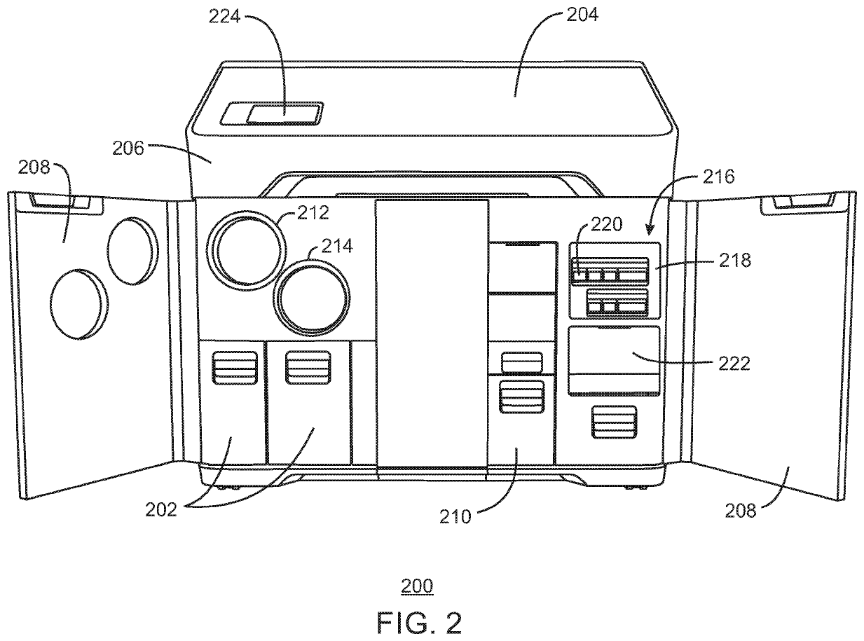

One example of a system that may use the techniques is the three-dimensional (3D) printer described with respect to FIGS. 2 to 7. The techniques are not limited to a system using this configuration, and may be implemented in any number of systems, including, for example, 3D printers or 2D printers, among others.

FIG. 2 is a drawing of a 3D printer 200, in accordance with examples. The 3D printer 200 may be used to generate a 3D object from a build material, for example, on a build platform in a build chamber or enclosure. As described herein, the build material may be a powder, and may include a plastic, a metal, a glass, or a coated material, such as a plastic-coated glass powder, among others.

The printer 200 may have covers or panels over compartments 202 for internal material vessels that hold build material. The material vessels may discharge build material through feeders into an internal conveying system for the 3D printing. The printer 200 may have a controller to adjust operation of the feeders to maintain a desired composition of build material including a specified ratio of materials in the build material. The internal material vessels may be removable via user-access to the compartments 202. The printer 200 may have a housing, and components internal to the housing, for handling of build material. The printer 200 has a top surface 204, a lid 206, and doors or access panels 208. The access panels 208 may be locked during operation of the 3D printer 200. The printer 200 may include a compartment 210 for an additional internal material vessel such as a recovered material vessel holding recovered unfused or excess build material from a build enclosure of the printer 200.

The build material may be added or removed from the 3D printer through build material containers that are horizontally inserted into supply stations. The supply stations may include a new supply station 212 for the addition of new build material, and a recycle supply station 214 for the addition of recycled build material. The recycle supply station 214 may also be used to offload recovered build material, for example, from the recovered material vessel or a hopper, among others. In one example, a single supply station may be provided which may be used for both adding new build material and for removing recycled build material from the printer.

In some examples, the 3D printer 200 may use a print liquid for use in a selective fusing process, or other purposes, such as decoration. For examples of a 3D printer 200 that employ a print liquid, a print-liquid system 216 may be included to receive and supply print liquid for the 3D printing. The print-liquid system 216 includes a cartridge receiver assembly 218 to receive and secure removable print-liquid cartridges 220. The print-liquid system 216 may include a reservoir assembly 222 having multiple vessels or reservoirs for holding print liquid collected from the print-liquid cartridges 220 inserted into the cartridge receiver assembly 218. The print liquid may be provided from the vessels or reservoirs to the 3D printing process, for example, to a print assembly or printbar above a build enclosure and build platform.

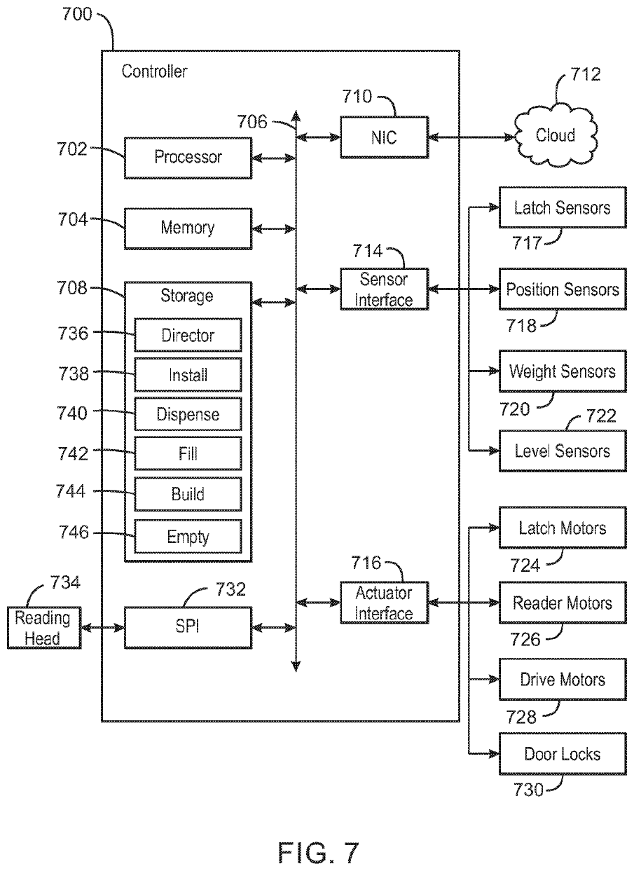

The 3D printer 200 may also include a user control panel or control interface 224 associated with a computing system or controller of the printer 200. The control interface 224 and computing system or controller may provide for control functions of the printer 200. The fabrication of the 3D object in the 3D printer 200 may be under computer control. A data model of the object to be fabricated and automated control may direct the layered manufacturing and additive fabrication. The data model may be, for example, a computer aided design (CAD) model, a similar model, or other electronic source. As described with respect to FIG. 7, the computer system, or controller, may have a hardware processor and memory. The hardware processor may be a microprocessor, CPU, ASIC, printer control card, or other circuitry. The memory may include volatile memory and non-volatile memory. The computer system or controller may include firmware or code, e.g., instructions, logic, etc., stored in the memory and executed by the processor to direct operation of the printer 200 and to facilitate various techniques discussed herein.

If identical parts are to be sequentially built in multiple runs, the controller may be set not to empty internal vessels. However, if a part being formed in a build operation is a single part, or the last in a series of sequentially built parts, the controller may be set to empty internal vessels, such as the hoppers and lines, allowing an easier transition to a new build material. In some examples, the internal vessels may be emptied between every build operation to allow a fresh mixture to be used, for example, if every build operation is returning to a particular ratio of new and recycled material.

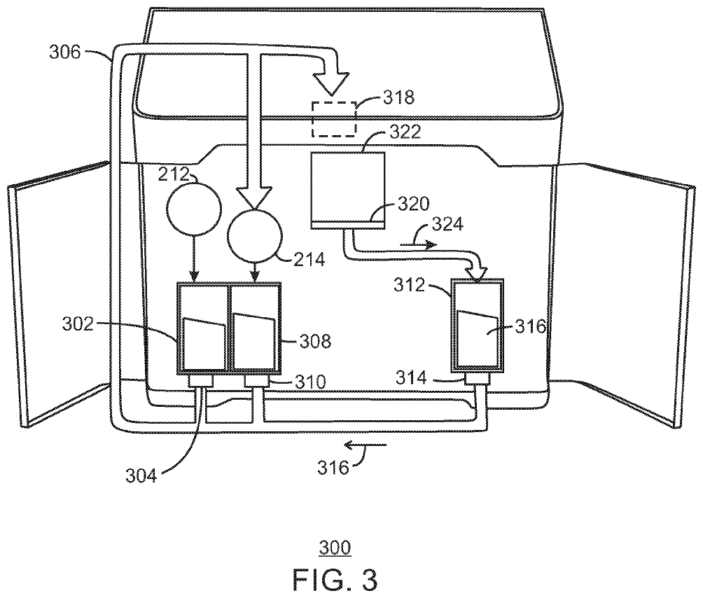

FIG. 3 is a schematic diagram of a 3D printer 300 having an internal new material vessel 302 that discharges new build material through a new feeder 304 into a conveying system 306, in accordance with examples. Like numbered items are as described with respect to FIG. 2. The printer 300 may include a recycle material vessel 308 to discharge recycle build material through a recycle feeder 310 to the conveying system 306. The printer 300 may have a controller to adjust operation of the feeders 304 and 310 to maintain a composition and discharge rate of the build material for the 3D printing. Further, the printer 300 may include a recovered material vessel 312 to discharge recovered material 316 through a recovery feeder 314 into the conveying system 306. The conveying system 306 may transport the build material to a dispense vessel 318 which may supply build material for 3D printing. In the illustrated example, the dispense vessel 318 is disposed in an upper portion of the 3D printer 300. Moreover, although the conveying system 306 for the build material is depicted outside of the 3D printer 300 for clarity in this schematic view, the conveying system 306 is internal to the housing of the printer 300.

The 3D printer 300 may form a 3D object from the build material on a build platform 320 associated with a build enclosure 322. The 3D printing may include selective layer sintering (SLS), selective heat sintering (SHS), electron beam melting (EBM), thermal fusion, chemical binders, liquid fusing agents, or other 3D printing and additive manufacturing (AM) technologies to generate the 3D object from the build material. Recovered build material 324, for example, non-solidified or excess build material, may be recovered from the build enclosure 322, for example, falling from the build platform 320, or being removed from around the edges of the build enclosure 322 by a perimeter vacuum. The recovered build material 324 may be treated and returned to the recovered material vessel 312.

As described herein, a new supply station 212 and a recycle supply station 214 may hold build material containers inserted by a user. The supply stations 212 and 214 may provide new or recycled build material for the 3D printing to the new and recycle material vessels 302 and 308, respectively. Further, the conveying system 306 may return recovered material 316 to the recycle supply station 214. The recovered material 316 may be offloaded by being added to a build material container inserted in the recycle supply station 214, or may be diverted through the recycle supply station 214 to the recycle material vessel 308. The recovered material 316 may include build material obtained by emptying conveying lines and hoppers in the 3D printer.

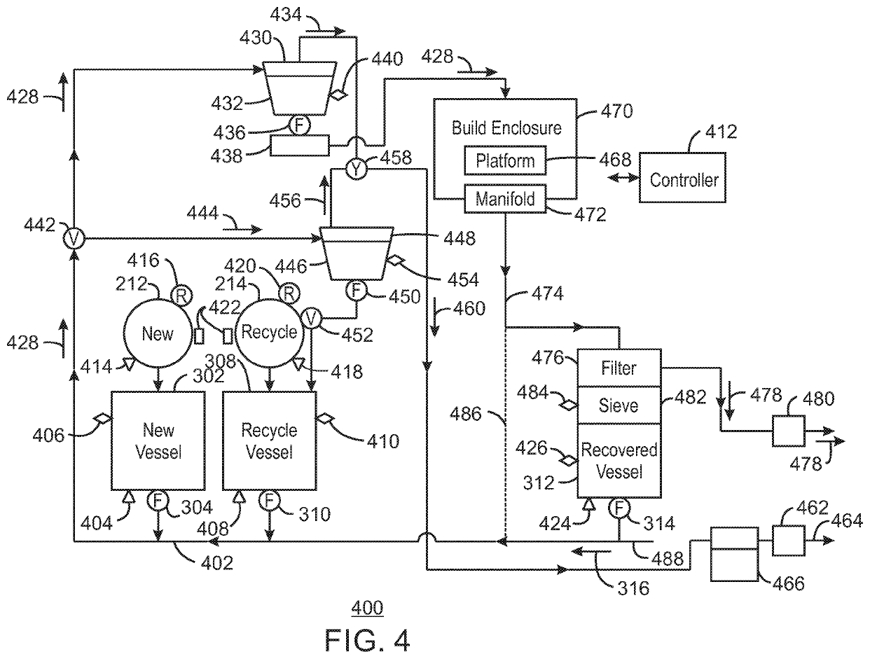

FIG. 4 is a block diagram of a 3D printer 400, in accordance with examples. Like numbered items are as described with respect to FIGS. 2 and 3. As shown in this drawing, material flows are shown by labelled arrows placed along conveying lines or conduits, which may be separately labeled. In this example, the 3D printer 400 may have a new material vessel 302 that discharges new material through a new feeder 304, such as a rotary feeder, auger, or screw feeder, into a conduit on a first conveying system 402, which may be a pneumatic conveying system. The new feeder 304 may meter or regulate material discharge or otherwise facilitate dispensing of the desired amount of new material from the new material vessel 302 into the first conveying system 402. In addition, the 3D printer 400 may include a recycle material vessel 308 that discharges recycle material through a recycle feeder 310 into the first conveying system 402.

The new material vessel 302 may have a weight sensor 404 and a fill level sensor 406. Likewise, the recycle material vessel 308 may have a weight sensor 408 and a fill level sensor 410. A controller 412 of the printer 400, as described with respect to FIG. 7, may adjust operation of the feeders 304 and 310 in response to indications of material discharge amount or rate provided by the weight sensors 404 and 408. The adjustment of the feeders 304 and 310 may be used to maintain a desired ratio of new material to recycle material. In examples described herein, the controller 412 may control the emptying of build material from internal lines and vessels in the 3D printer 400.

The 3D printer 400 may include a new supply station 212 to hold a build material container for adding new build material in a cylindrical cage, along a horizontal axis. The new material vessel 302 may receive new build material from the build material container held by the new supply station 212. As described herein, the new supply station 212 may include sensors and actuators to determine if a build material container is present, and to control the dispensing of build material from the build material container. The sensors may include a weighing device 414 that may be used to determine the weight of the new supply station 212 and the build material container. The actuators may include a motor 416 to rotate the cylindrical cage in a first angular direction to dispense build material to the new material vessel 302.

The number of rotations of the cylindrical cage may be used to control the dispensing of an expected amount of build material from a build material container. Accordingly, the motor 416 may be a stepper motor, a servo motor, or other type of motor that may be used to control the number of revolutions and the speed of the rotation. In some examples, a motor having a controlled speed, such as a motor control using pulse width modulation or pulse frequency modulation, may be used with a sensor that counts the number of revolutions. For example, a base position sensor as described herein may be used to count the revolutions.

The 3D printer 400 may include a recycle supply station 214 to hold a build material container for recycled material. As described for the new supply station 212, the recycle supply station 214 may include several sensors and actuators to determine if a build material container is present, and control the dispensing of recycled build material from the build material container, for example, into a recycled material vessel. The sensors may include a weighing device 418 that may be used to determine the weight of the recycle supply station 214 and a build material container. The actuators may include a motor 420 to rotate the cylindrical cage in a first angular direction to dispense build material to the recycle material vessel 308. The recycle supply station 214 may also rotate the cylindrical cage in a second angular direction, opposite the first angular direction, to add recovered or recycled material to the build material container.

The new supply station 212 and the recycle supply station 214 may also include other sensors and actuators 422 to provide functionality. A latching sensor may determine if a build material container is secured in a supply station, and a position sensor to determine if a build material container is in a base position, among others. As used herein, a base position is an initial position of the build material container after insertion into a supply station 212 or 214. In the base position, sensors and actuators 422 on a support structure may interact with the cylindrical cage. Further, the sensors and actuators 422 may include actuators to actuate a valve on the build material container, for example, opening or closing the valve, or advance the read head to an information chip on a build material container, among others.

As described herein, the printer 400 may include a recovered material vessel 312 which discharges recovered material 316 through a recovery feeder 314 into the first conveying system 402. The recovered material vessel 312 may have a weight sensor 424 and a fill level sensor 426. Accordingly, the build material 428 may include recovered material 316 from the recovered material vessel 312 in the build material in addition to the recycle material from the recycle material vessel 308 and new material from the new material vessel 302.

Conveying air may flow through the first conveying system 402. An air intake such as a filtered manifold or an open conduit as may receive, pull in, and/or filter air (e.g., ambient air) as conveying air for the first conveying system 402. The air may also be used for the second conveying system discussed below. The first conveying system 402 may transport the build material 428, for example, a mixture of new build material, recycled build material, or recovered material 316. In the illustrated example, the first conveying system 402 may convey the build material 428 to a separator 430 associated with a dispense vessel 432. The dispense vessel 432 may be a feed hopper. The separator 430 may include a cyclone, a screen, a filter, and the like. The separator 430 may separate conveying air 434 from the build material 428.

After the conveying air 434 has been separated, the build material 428 may flow into the dispense vessel 432. A feeder 436 may receive build material from the dispense vessel 432 and discharge the build material to a build material handling system 438 for the 3D printing. The dispense vessel 432 may have a fill level sensor 440. The fill level sensor 440 may measure and indicate the level or height of build material in the dispense vessel 432.

As described herein, once a build operation is finished, and a 3D part has been formed, the dispense vessel 432 may be emptied through the feeder 436 to the build material handling system 438. The build material handling system 438 may then empty the residual build material 428 to the build enclosure 470, for example, to be formed into a z-thermal margin layer. In some examples, the residual build material may be sent to a perimeter vacuum located around the edges of the build enclosure 470. As described herein, the dispense vessel 432, or hopper, may be sized to minimize the amount of build material held in the dispense vessel 432.

The first conveying system 402 may divert build material 428 via a diverter valve 442. The diverted material 444 may be sent to an alternate vessel 446, or hopper, through a separator 448 such as cyclone, filter, etc. The alternate vessel 446 may discharge the diverted material 444 through a feeder 450 and diverter valve 452 to either a build material container in the supply station 214, or to the recycle material vessel 308.

As described for the dispense vessel 432, the alternate vessel 446 may be emptied at the end of the build cycle. This may be performed by sending any remaining build material through the feeder 450 to the diverter valve 452. From the diverter valve 452, the remaining build material may be sent to a build material container inserted into the recycle supply station 214, or to the recycle material vessel 308. The design of the alternate vessel 446 may also be similar to that of the dispense vessel 432, for example, the alternate vessel 446 may be sized to minimize the amount of build material 428 held.

The build material 428 may be diverted by the diverter valve 442 as diverted material 444 when the build material 428 is primarily recycle material or recovered material 316. This may be performed to offload material, for example, by diverting the material through diverter valve 452 to a build material container. In other examples, the diverted material 444 may be sent by the diverter valve 452 to the recycle material vessel 308. As with other material vessels, the alternate vessel 446 may have a fill level sensor 454.

The separator 448 associated with the alternate vessel 446 may remove conveying air 456 from the build material 428. After the conveying air 456 is removed from the build material 428, the build material 428 may discharge from the separator 448 into the alternate vessel 446. In the illustrated example, the conveying air 456 from the separator 448 may flow to a Y-fitting 458, where the conveying air 456 is combined with the conveying air 434 from the separator 430 associated with the dispense vessel 432. The Y-fitting 458 may be a conduit fitting having two inlets and one outlet. The combined conveying air 460 may be pulled from the Y-fitting 458 by a motive component 462 of the first conveying system 402 and discharged 464 to the environment or to additional equipment for further processing. In some examples, the combined conveying air 460 may flow through a filter 466 as it is being pulled out by the motive component 462. The filter 466 may remove particulates from the conveying air 460 before it is discharged 464.

The motive component 462 provides motive force for the conveying air in the first conveying system 402 to transport build material. The motive component 462 may be an air blower, eductor, ejector, vacuum pump, compressor, or other motive component. Because the first conveying system 402 is generally a pneumatic conveying system, the motive component may typically include a blower such as a centrifugal blower, fan, axial blower, and the like.

As for the 3D printing, as mentioned, the dispense vessel 432 may discharge the build material 428 through a feeder 436 to the build material handling system 438. The feeder 436 and the build material handling system 438 may provide a desired amount of build material 428 across a build platform 468, for example, in layers. The build material handling system 438 may include a feed apparatus, dosing device, build-material applicator, or powder spreader, and the like, to apply the build material to the build platform 468 in the build enclosure 470. The printer 400 may form a 3D object from build material 428 on the build platform 468.

After the 3D object is complete or substantially complete on the build platform 468, a vacuum manifold 472 may remove excess build material from the build enclosure 470 into a second conveying system 474 as recovered material. In some examples, a second conveying system 474 is not used. For example, the excess build material may be off-loaded with the 3D object or removed by a stand-alone vacuum.

If the second conveying system 474 is used, it may convey the recovered material through a cyclone or filter 476 to separate the recovered material from the conveying air 478. The conveying air 478 is discharged through a motive component 480 of the second conveying system 474. A filter may be included to remove particulates from the conveying air 478. The motive component 480 may be a blower, fan, eductor, ejector, vacuum pump, or other type of motive component. In this example, the recovered material may discharge from the cyclone or filter 476 and enter a sieve 482 where larger particles, such as solidified build material not incorporated into the 3D object, may be removed. The sieve 482 may have a fill level sensor 484 which monitors the level or height of solid material in the sieve 482.

After separation of the larger particles, the recovered build material may enter the recovered material vessel 312. In some examples, the recovered material may bypass the cyclone or filter 476, sieve 482, and recovered material vessel 312 and flow into a conduit of the first conveying system 402, as indicated by the dashed line 486. The vessels, conveying systems, and associated equipment of the 3D printer 400 may include instrumentation such as pressure sensors and temperature sensors, and the like. Further, the first conveying system 402 includes an air intake 488, positioned before the first vessel in the first conveying system 402.

The 3D printer 400 may fabricate objects as prototypes or products for aerospace (e.g., aircraft), machine parts, medical devices (e.g., implants), automobile parts, fashion products, structural and conductive metals, ceramics, and so forth. In one example, the 3D objects formed by the 3D printer 400 are mechanical parts which may be metal or plastic, and which may be equivalent or similar to mechanical parts produced by other fabrication techniques, for example, injection molding or blow molding, among others.

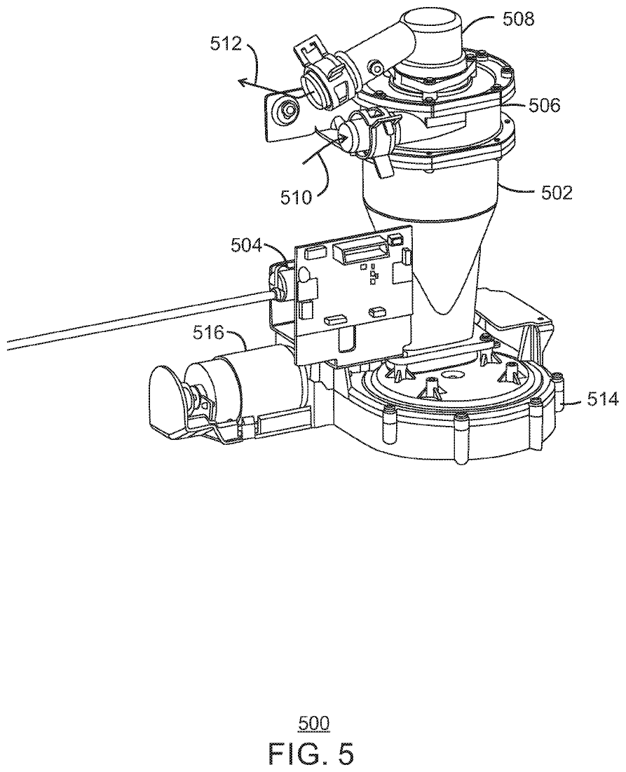

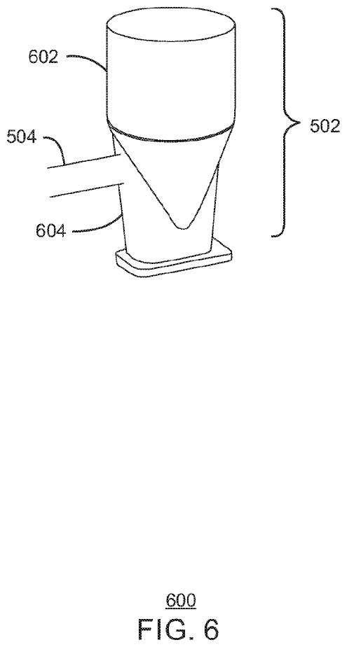

FIG. 5 is a drawing of a system 500 having a hopper 502 in a 3D printer, in accordance with examples. Referring also to FIG. 4, the hopper 502 may correspond to the dispense vessel 432 or the alternate vessel 446, described with respect to FIG. 4. The hopper 502 has a level sensor 504 positioned between upper and lower portions of the hopper 502, as described further with respect to FIG. 6.

A cyclone 506 positioned above the hopper 502 receives an air stream 510 conveying the build material. An air separator 508 positioned at the center top of the cyclone 506 separates a stream of conveying air 512 from the cyclone 506, while the build material is allowed to drop into the hopper 502. From the hopper 502, a feeder 514, such as a rotary valve driven by a motor 516, removes the material from the hopper 502 to send it to a next vessel. For example, the feeder 514 may correspond to the feeder 436 at the bottom of the dispense vessel 432, or the feeder 450 at the bottom of the alternate vessel 446.

FIG. 6 is a drawing 600 of the hopper 502, showing the size differences between the top portion 602 and bottom portion 604, in accordance with examples. Like numbered items are as described with respect to FIG. 5. The top portion 602 of the hopper 502 may be located above the level sensor 504 and may hold about 245 cm³ of build material, and the bottom portion 604 is located below the level sensor 504 and may hold about 163 cm³ of build material. As the level sensor 504 may be used to switch off the conveying system, stopping the addition of build material to the hopper 502, extra material may generally only remain in the bottom portion 604 of the hopper 502 between build operations. Thus, the bottom portion 604 of the hopper 502 may be designed to hold less than about 200 cm³, or approximately 80 g, of build material.

The amount of build material in the bottom portion 604 is sufficient for about 8 to 10 layers, and may easily be emptied at the end of a build operation. For example, build material in the dispense vessel 432 of FIG. 4 may be emptied to the build material handling system 438 for incorporation into a z-thermal margin layer. For example, at the end of a build job, any remaining build material in the dispense hopper may be used to form additional layers of build material on top of the current layers of build material. These additional layers may not be selectively solidified. In some examples, the extra material may be sent into a perimeter vacuum system. Similarly, build material in the alternate vessel 446 of FIG. 4 may be emptied to the recycle supply station 214 to be dumped to the recycle material vessel 308 or offloaded to a build material container.

FIG. 7 is a block diagram of a controller 700 for operating a supply station in a 3-dimensional printer, in accordance with examples. The controller 700 may be part of the main controller for the 3D printer, or a separate controller associated with the supply stations.

The controller 700 may include a processor 702, which may be a microprocessor, a multi-core processor, a multithreaded processor, an ultra-low voltage processor, an embedded processor, or other type of processor. The processor 702 may be an integrated microcontroller in which the processor 702 and other components are formed on a single integrated circuit board, or a single integrated circuit, such a system on a chip (SoC). As an example, the processor 702 may include a processor from the Intel® Corporation of Santa Clara, Calif., such as a Quark™, an Atom™, an i3, an i5, an i7, or an MCU-class processor. Other processors that may be used may be obtained from Advanced Micro Devices, Inc. (AMD) of Sunnyvale, Calif., a MIPS-based design from MIPS Technologies, Inc. of Sunnyvale, Calif., an ARM-based design licensed from ARM Holdings, Ltd. or customer thereof, or their licensees or adopters. The processors may include units such as an A5-A10 processor from Apple® Inc., a Snapdragon™ processor from Qualcomm® Technologies, Inc., or an OMAP™ processor from Texas Instruments, Inc.

The processor 702 may communicate with a system memory 704 over a bus 706. Any number of memory devices may be used to provide for a given amount of system memory. The memory may be sized between about 2 GB and about 64 GB, or greater. The system memory 704 may be implemented using volatile memory devices, such as RAM or static RAM (SRAM). Further, nonvolatile memory may be used, such as memory modules having backup power, for example, from batteries, super-capacitors, or hybrid systems.

Persistent storage of information such as data, applications, operating systems, and so forth, may be performed by a mass storage 708 coupled to the processor 702 by the bus 706. The mass storage 708 may be implemented using a solid-state drive (SSD). Other devices that may be used for the mass storage 708 include flash memory cards, such as SD cards, microSD cards, xD picture cards, and the like, and USB flash drives. In some examples, the controller 700 may have an accessible interface, such as a USB connection, an SD card socket, or a micro-SD socket to all the insertion of memory devices with build plans, instructions, and the like.

In some examples, the mass storage 708 may be implemented using a hard disk drive (HDD) or micro HDD. Any number of other technologies may be used in examples for the mass storage 708, such resistance change memories, phase change memories, holographic memories, or chemical memories, among others.

The components may communicate over the bus 706. The bus 706 may include any number of technologies, such as industry standard architecture (ISA), extended ISA (EISA), peripheral component interconnect (PCI), peripheral component interconnect extended (PCIx), PCI express (PCIe), or any number of other technologies. The bus 706 may include proprietary bus technologies, for example, used in a SoC based system. Other bus systems may be included, such as an I2C interface, I3C interface, an SPI interface, point to point interfaces, and a power bus, among others. A network interface controller (NIC) 710 may be included to provide communications with a cloud 712 or network, such as a local area network (LAN), a wide area network (WAN), or the Internet.

The bus 706 may couple the processor 702 to interfaces 714 and 716 that are used to connect to other devices in the 3D printer. For example, as described with respect to FIG. 4, a sensor interface 714 may be used to couple to latch sensors 717 to detect if a build material container is latched in a supply station, and position sensors 718 to detect if a build material container is in a base position in a supply station. Other sensors that may be present in examples include weight sensors 720 to determine the weights of various containers or vessels, such as the supply stations, the new material vessel, the recycle material vessel, or the recovered material vessel, among others. Level sensors 722 may be coupled to the sensor interface 714 to monitor the level of build material in various vessels, such as the hoppers, the new material vessel, the recycle material vessel, or the recovered material vessel, among others. The level sensors may be used to determine if the level in the hopper is above the lower portion, and to control the addition of material to the hopper, for example, conveying material to a hopper until the level registers on the level sensor.

An actuator interface 716 may be included to control various actuators in the 3D printer. The actuators may include latch motors 724, to release build material containers from supply stations, and reader motors 726 to move reading heads towards, and away from, information chips on build material containers. Drive motors 728 may be used to rotate cylindrical cages that hold build material containers. The drive motors 728 may be stepper motors, server motors, or other kinds of motors that have rotation controlled by the supplied power signal, allowing the number of revolutions per minute in total revolutions to be controlled by the actuation. The drive motors 728 may include motors that rotate the feeders, facilitating a controlled removal of build material from the hoppers.

The actuation interface 716 may also couple to door locks 730 which may be used to lock the doors to prevent access to the build material containers while they are being moved. A serial peripheral interface (SPI) 732 may be coupled to the reading head 734 for interface with an information chip on a build material container. Other types of interfaces may also be used to read the information chip, such as a two wire I2C serial bus. In some examples, the information chip may be accessed through an RFI system.

While not shown, various other input/output (I/O) devices may be present within, or connected to, the controller 700. For example, a display panel may be included to show information, such as build information, action prompts, warnings of incorrect material, or messages concerning status of doors, build material containers, and the like. Audible alarms may be included to alert a user of a condition. An input device, such as a touch screen or keypad may be included to accept input, such as instructions on new builds, and the like.

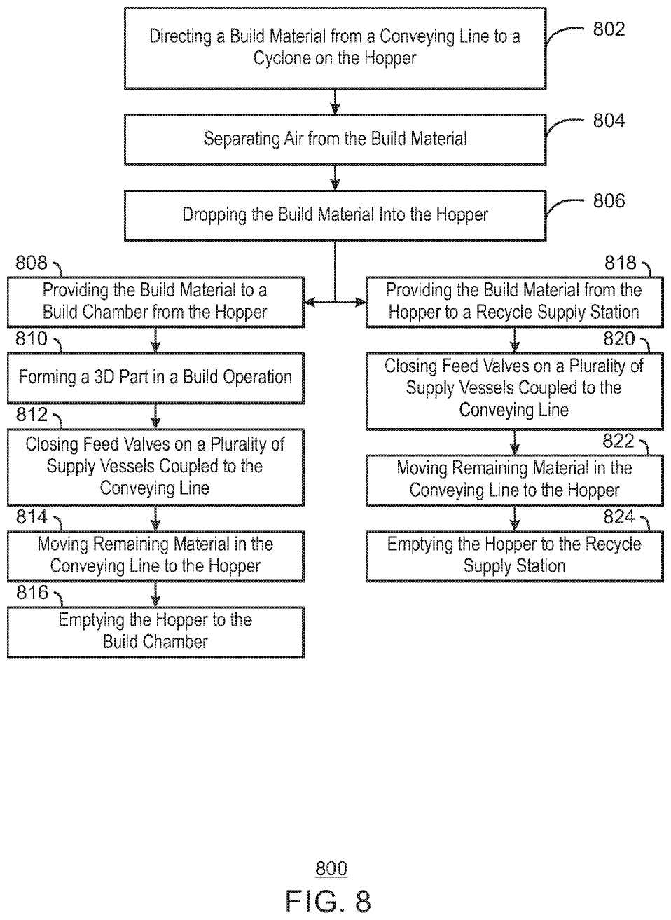

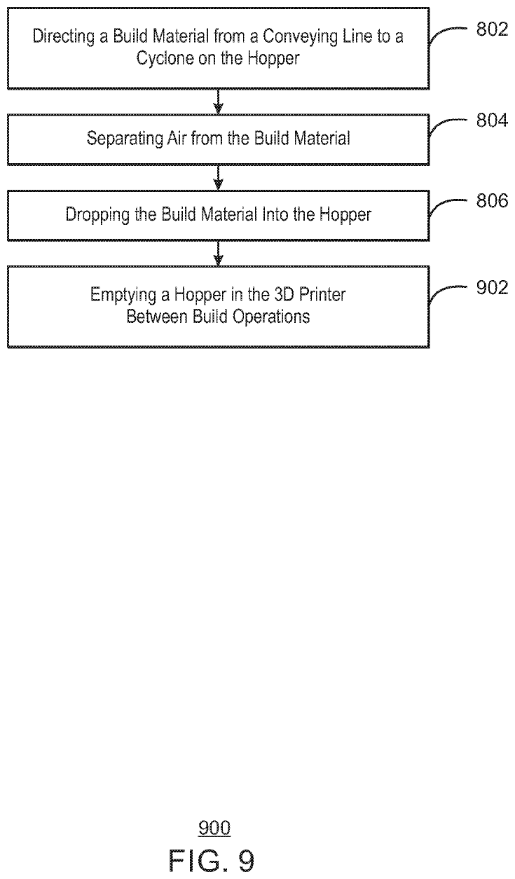

The mass storage 708 may include modules to control the emptying of material from the hoppers, as described herein. Although shown as code blocks in the mass storage 708, it may be understood that any of the modules may be fully or partially implemented in hardwired circuits, for example, built into an application specific integrated circuit (ASIC). The modules may generally be used to implement the functions described with respect to FIGS. 8 and 9.

A director module 736 may implement the general functions for setting up the supply station and build operations. These may include the general operations not included in one of the more specific procedures, such as getting job instructions, estimating revolutions required to dispense or add build material, and moving recovered build material directly into the recycle material vessel past the recycle supply station.

An install module 738 may implement an installation procedure for installing a build material container in a supply station, for example, determining if the build material container includes the correct material type, and rejecting the build material container if not, among others. A dispense module 740 may implement a dispense procedure used to dispense build material from a build material container, such as monitoring the number of revolutions of the build material container during the dispense procedure and the level of the vessel accepting the build material, among others. A fill module 742 may implement a fill procedure used to add build material to a build material container in the recycle supply station, such as when build material emptied from a hopper is added to a build material container.

A build module 744 may direct the build operation for forming the 3D object. The build module 744 may trigger instructions for emptying the hoppers at the end of a build operation by activating an empty module 746. The instructions may be part of the build operation contained in a file. The instructions may be used when a single build operation is performed or when a build operation is the final build operation of a sequence of build operations. In some examples, the hoppers may be emptied at the end of each build operation.

The empty module 746 may direct the emptying of the hoppers, such as the dispense vessel 432 or the alternate vessel 446, described with respect to FIG. 4. The empty module 746 may be used to perform the methods of FIG. 8 or 9.

FIG. 8 is a process flow diagram of a method 800 for operating a 3D printer, in accordance with examples. The method 800 may begin in the build operation at block 802 when a build material is directed from the conveying line to a cyclone, or other separator, on a hopper, or other intermediate vessel. At block 804, air may be separated from the build material. At block 806, the build material may be fed into the hopper.

The method 800 to empty the hopper depends on which hopper is being emptied. Emptying the dispense vessel 432 (FIG. 4), which feeds the build chamber, is described with respect to blocks 808 to 816. At block 808, the build material is provided to a build chamber from the hopper, while the build operation is taking place. At block 810, a 3D part is formed in the build operation. At block 812, after the build operation is completed, feed valves on supply vessels coupled to the conveying line may be closed. In some examples, this may be performed by stopping the rotation of a feeder.

At block 814, any remaining material in the conveying line is moved to the hopper. This may be performed by continuing to operate the conveying system after the feeders have stopped rotating. At block 816, the build material in the hopper may be emptied to the build chamber by rotating the feeder at the base of the hopper. The empty build material may be used to form a layer of un-sintered material over the 3D part, termed a z-thermal margin layer herein. The build material in the hopper may also be disposed of by disposing of it in a perimeter vacuum located outside the edges of the build platform.

Emptying the alternate vessel 446 (FIG. 4), which feeds recycled material to the recycle supply station, is described with respect to blocks 818 to 824. At block 818 build material is provided from the hopper to the recycle supply station. The build material may be fed to a build material container in the recycle supply station for offloading or may be diverted to the recycle vessel for later use.

At block 820, after the build operation is completed, feed valves on supply vessels coupled to the conveying line may be closed. In some examples, this may be performed by stopping the rotation of a feeder. At block 822, any remaining material in the conveying line is moved to the hopper. This may be performed by continuing to operate the conveying system after the feeders have stopped rotating. At block 824, the build material in the hopper may be emptied to the recycle supply station by rotating the feeder at the base of the hopper. The build material from the hopper may be offloaded to a build material container in the recycle supply station, diverted to the recycle vessel, or both.

FIG. 9 is a simplified process flow diagram of a method 900 for operating a 3D printer, in accordance with examples. Like numbered items are as described with respect to FIG. 8. At block 902, a hopper in the 3D printer is emptied between build operations.

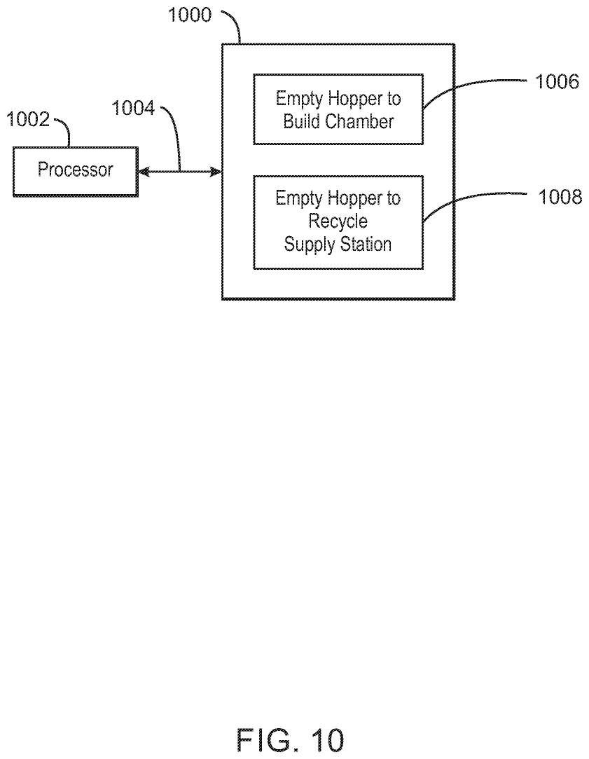

FIG. 10 is a block diagram of a non-transitory, machine readable medium including code to direct a processor 1002 to operate a 3D printer, in accordance with examples. The processor 1002 may access the non-transitory, machine readable medium 1000 over a bus 1004. The processor 1002 and bus 1004 may be as described with respect to the processor 702 and bus 706 of FIG. 5. The non-transitory, machine readable medium 1000 may include devices described for the mass storage 708 of FIG. 7 or may include optical disks, thumb drives, or any number of other hardware devices.

The non-transitory, machine readable medium 1000 may include code 1006 to direct the processor 1002 to empty a hopper to a build chamber. This may include, for example, the method described with respect to blocks 808 to 816 of FIG. 8. The non-transitory, machine readable medium 1000 may also include code 1008 to direct the processor 1002 to empty a hopper to a recycle supply station. This may include, for example, the method described with respect to blocks 818 to 824 of FIG. 8.

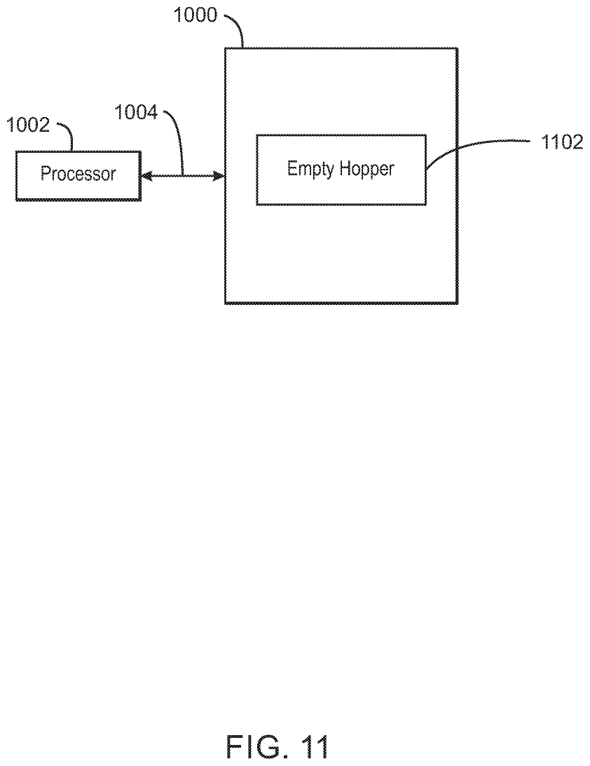

FIG. 11 is a simplified block diagram of a non-transitory, machine readable medium 1000 including code to operate a 3D printer, in accordance with examples. Like numbered items are as described with respect to FIG. 10. The non-transitory, machine readable medium 1000 may include code 1102 to direct the processor 1002 to empty a hopper.

While the present techniques may be susceptible to various modifications and alternative forms, the examples discussed above have been shown by way of example. It is to be understood that the techniques are not intended to be limited to the particular examples disclosed herein. Indeed, the present techniques include all alternatives, modifications, and equivalents falling within the scope of the present techniques.

What is claimed is:

1. A build device, comprising:
a conveying system comprising an intermediate vessel to store build material after the build material is separated from a conveying air stream, wherein the intermediate vessel is configured to be refilled during a build operation in order to complete the build operation; and
a control system configured to refill the intermediate vessel during the build operation, wherein the control system is configured to purge the intermediate vessel after the build operation is completed.

2. The build device of claim 1, wherein the intermediate vessel supplies build material to a build chamber.

3. The build device of claim 1, comprising a three-dimensional (3D) printer.

4. The build device of claim 3, wherein the intermediate vessel comprises a hopper, comprising:
a top portion;
a bottom portion; and
a level sensor disposed between the top portion and the bottom portion, wherein a volume of the top portion is greater than the volume of the bottom portion, the top portion flows into the bottom portion, and wherein the bottom portion is configured to be completely emptied between build operations.

5. The build device of claim 4, wherein the hopper is configured to be emptied to a build enclosure after the build operation.

6. The build device of claim 4, wherein the hopper is configured to be emptied to a recycle supply station after the build operation.

7. The build device of claim 1, comprising an air-separator coupled to the intermediate vessel.

8. The build device of claim 7, wherein the air-separator is a cyclone.

9. A method for operating a build device, comprising:
separating a build material from a conveying air stream into an intermediate vessel; and
emptying the intermediate vessel between a first build operation and a second build operation.

10. The method of claim 9, comprising purging the intermediate vessel to a build chamber.

11. The method of claim 9, comprising purging the build material to a storage vessel.

12. The method of claim 9, comprising performing a build operation using new build material after the emptying the intermediate vessel between the first build operation and the second build operation.

13. A non-transitory, machine readable medium, comprising code configured to direct a processor to purge an intermediate vessel in a 3D printer between a first build operation and a second build operation.

14. The non-transitory, machine readable medium of claim 13, comprising code configured to direct the processor to move any material remaining in the intermediate vessel after the first build operation to a build chamber.

15. The non-transitory, machine readable medium of claim 13, comprising code configured to direct the processor to move any material remaining in the intermediate vessel after the first build operation to a recycle supply station.
